(19) United States
(12) Patent Application Publication
(10) Pub. No.: US 2007/0095047 A1
(43) Pub. Date: May 3, 2007

(54) Fuel ignition system for jet engine staring

(76) Inventor: Simyon Rozenberg, Lod (IL)

Correspondence Address: Simyon Rozenberg, 9/29 San Martin str., Lod, 71279, IL

(21) Appl. No.: 10/536,089

(22) Filed: Nov. 3, 2005

(51) Int. Cl. F02C 7/264

(52) U.S. Cl. 60/39.823

(57) ABSTRACT

Fuel ignition system for jet engine starting contains pyrocartridges, connected by tubes to nozzles. The nozzles enter in a heat pipe so that the plumes hot pyrogases are in a zone of backflows of composite fuel. The pyrocartridges are connected to the electronic unit, control pyrocartridges and fuel supply.

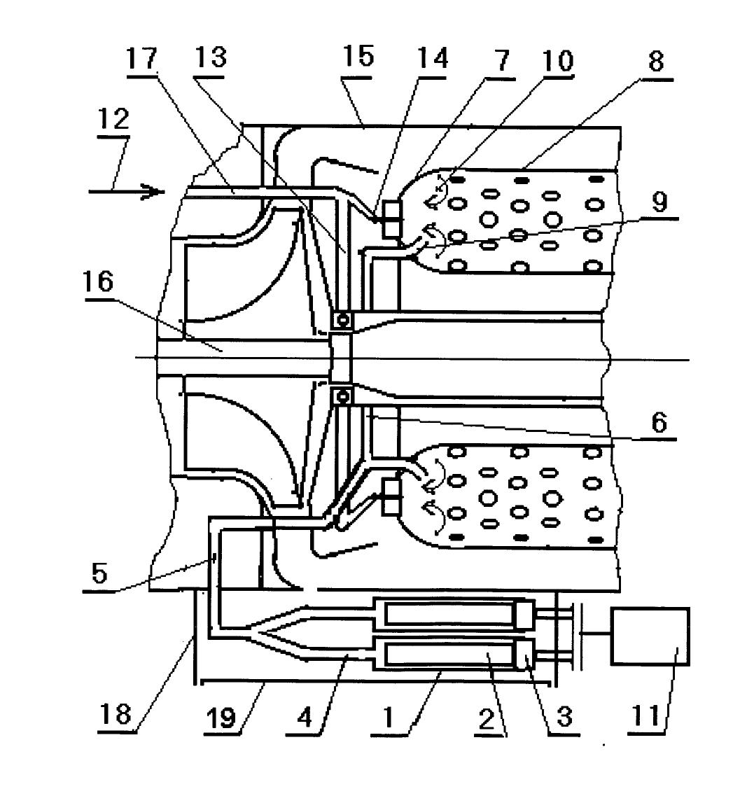

### BACKGROUND OF THE INVENTION

The present invention relates to equipment of jet engines and is destined for fuel ignition in combustion chambers (fire tubes) of jet engines, flying vehicles in particular.

At present fuel ignition systems are known to use electric spark plug for starting internal combustion engines (car engines in the first place); such systems are in principle suitable (taking into account parametric features) for starting jet engines as well, in particular flying and armored vehicles (which is certified by multiple variants of the systems existing in the open press and protected by patents at different times, with many of them having lost their exclusive rights and become tax-free property of humanity).

In relation to jet engines starting, the systems mentioned which use electric spark plug possess the following drawbacks.

Extension of stable engine starting ranges can be achieved by the deepest maximum submergence of electric spark plug into the fire tube (as close as possible to the zone of reverse flows), as well as by increasing electric energy delivered to spark plug from voltage transformer. With maximum working mode of the engine, strong heat flows are influencing the spark plug, that's why it is manufactured out of the best heat-resistant materials and use intensive cooling. But this intensive cooling decreases the stable engine starting range.

It is impossible to attain the desirable engine starting ranges with many engines in extreme conditions despite high electric energy and maximum heat-resistance of spark plug. Extreme starting conditions for an engine include engine starting at extremely low ambient temperatures of the air and fuel (winter starting), starting at great height and high speed of flight (in-flight starting), starting when using heavy kinds of fuel (diesel fuel in particular), contrary and anti-surge starting.

Voltage transformer, spark plug and high-voltage cable in this system are rather heavy due to high energy and necessity of providing electric strength, particularly with high-altitude conditions (with ambient air pressure lower than 200 mm Hg and voltage of several kV).

When using electric spark plug for starting liquid-propellant rocket engine all the equipment becomes more cumbersome and heavy due to high pressure in the engine and necessity of providing high tightness of spark plug and electric strength of all electric connections at great heights and in space.

Fuel ignition is also known to occur when starting liquid-propellant engine using liquid fuel and oxidant aided by a third component. The third component which is introduced into engine when starting, forms a self-igniting mixture with the main component. Disadvantages of using the third component are as follows: it necessitates a lot of auxiliary equipment: tanks, pipelines, pump, valves; besides, the third component is as a rule a rather explosive and aggressive liquid, thus necessitating additional protective measures.

With small jet engines (e.g. aircraft models) a set of ignition system using electric spark plug is matching the weight of the engine itself.

Many other technical solutions are also known destined at expanding the ranges of stable starting.

These systems use electric, microwave or laser devices for preliminary heating of either air or fuel, or atomized fuel; slowly burning gun-powder charges [3,4] or solid fuel [5] or solid oxidizer (the latter interacts with main components) are placed into combustion chambers (fire tubes).

Several solutions destined for application especially in rocket engines (see, e.g., [5,6,7,8,9]) have appeared recently in open publications which, naturally, are more complicated than those known from earlier sources and which do not fully satisfy the needs of the users of the similar technology (from the technical as well as from economical point of view).

Flame ignition of fuel is also known for starting jet engine by means of a special device—flame igniter [2]. Flame igniter is positioned outside the fire tube and is fitted with an injector for starting fuel supply, an electric spark plug and an outlet pipe. Igniter outlet pipe should be installed in such a way that starting fuel combustion products enter the fire tube as close to the zone of reverse gas flows as possible. Main fuel is used as starting fuel, and in old engines petrol was used. A system of air blowing is installed on the engine for injector servicing. Voltage transformer and high voltage cable are used for spark plug smooth functioning.

There are the following disadvantages in application of ignition system using flame igniter: a lot of auxiliary equipment and its big weight, besides, igniter outlet pipe cannot be installed so that starting fuel combustion products enter the fire tube sufficiently close to the zone of reverse gas flows delivery (in some engines).

Hereby, the author [2] underlines that fuel decomposition and coking inside injector outlet during idling present the most serious problems with flame igniters. This causes plugging in of the injector outlet which is manufactured of a very small diameter (about 0.23 mm) for better spraying of a small quantity of the starting fuel. Additional technical means leading to considerable complication of the ignition system and additional weight are necessary for eliminating the problem mentioned.

The closest technical solution to the proposed invention is concerned with application of ignition cartridge for starting gas-turbine engine (see patent GB 627 722 [1]).

Ignition cartridge is installed on the engine body. Explosive gases flame which is created for igniting the fuel mixture is oriented transverse to the fire tube axis and is directed into the area of the fuel spraying cone. Ignition cartridge functions from one quarter of a second till one second. This means that the ignition cartridge is situated on the engine in the same way as electric spark plug or ignition outlet pipe. Information on the processes observed during gas-turbine engines starting was limited at the time of patent publishing (1947). It is impossible to achieve necessary starting ranges with the position of ignition cartridge mentioned, such small time of cartridge functioning and with mechanical automatic devices controlling starting. Modern series gas-turbine engines do not use ignition cartridges for fuel ignition when starting.

The aim of the proposed invention consists in increasing safety and stability with jet engine functioning (when using the ignition system proposed as an additional one to the main ignition system), as well as in increasing explosion safety and stability with engine testing and exploitation with simultaneous decrease in the weight of equipment set and the ignition system itself (when using the proposed ignition system as a single one for the engine).

### SUMMARY OF THE INVENTION

The aim set forth is attained by means of the proposed system for fuel ignition when starting a jet engine based on application of flames of hot explosive gases in the zone of fuel mixture reverse flows inside fire tubes of the engine.

The ignition system comprises a set of ignition cartridges having a number of cartridges not less than the number of prognosed engine starts in one operation cycle, where each ignition cartridge with powder mixture and ignition torch is connected to the pipe for explosive gas outlet through intermediate elements, and the said pipe is connected to the tube leading to the tubular circular collector; the latter being positioned in front of the fire tube head and fitted with outlet tubes having nozzles at their ends, each nozzle being situated on the fire tube head and enters it.

Each nozzle is oriented inside the fire tube so that during starting flames of hot explosive gases are formed in the zone of fuel mixture reverse flows ahead time for fuel delivery; with the length of the said flames longer than the distance between the nozzle section and reverse flow zone, and with explosive gases temperature higher than that of fuel mixture ignition.

In this case ignition torches of cartridges are connected to an electronic control block which provides for the calculated moment of the electric pulse being sent to the ignition torch (device) and the initial moment of supplying fuel to the fuel collector with injectors, each positioned in the fire tube head.

In the system the quantity and composition of the powder mixture, ratio between lengths and diameters of tubes and nozzles have been chosen for providing the given values of powder mixture burning velocity, temperature of explosive gases and length of explosive gases flames formed, as well as the time of flames burning in the zone of fuel mixture reverse flows.

The said tubular collector can be made in the form of a complete or incomplete ring.

Ignition cartridges and tubes for explosive gas outlet are fitted with thermal insulation sufficient for eliminating self-ignition of neighboring ignition cartridges.

In the system, the set of ignition cartridges, tubes for explosive gases outlet and part of the tube connected to a circular collector can be placed in an air-tight compartment with an air-tight cover, and the compartment chamber can be pneumatically connected to the fire tube chamber for equalizing pressure.

### BRIEF DESCRIPTION OF THE DRAWING

The invention is illustrated by a drawing attached where a gas-turbine jet engine with the proposed fuel ignition system is presented as a sectional view.

### DESCRIPTION OF THE PREFERRED EMBODIMENTS

Ignition system comprises ignition cartridges set 1 wherein the number of ignition cartridges is not less than the number of engine starts during one operation cycle and where each ignition cartridge with powder mixture 2 and ignition torch 3 is connected by explosive gas outlet tube 4 through intermediate elements (e.g. blow-out disk or internal nozzle) to the engine; the said tube 4 being connected to tube 5 leading to tubular circular collector 6; the latter being positioned before head 7 of fire tube 8 and is fitted with outlet pipes having nozzles 9 on the other end, each of these nozzles being positioned on head 7 of fire tube 8 and enters fire tube 8.

Each nozzle 9 is oriented in the fire tube so that during starting operation they provide for the appearance of hot explosive gases flames in zone 10 of fuel mixture reverse flows. (Characteristics of explosive gases flames are given lower in the same division of the description).

The said tubular collector 6 can be made in the form of a closed or open ring.

In this case ignition torches 3 of ignition cartridges 1 are switched in to electronic control block 11 calculating the moment of electric pulse delivery to ignition torch 3 and the moment of fuel 12 delivery to fuel collector 13 with injectors 14 at the outlet, each positioned in head 7 of fire tube 8.

Jet engine (e.g., gas-turbine) is, naturally, enclosed into casing 15 and besides fire tube (tubes) 8 is fitted with a shaft with compressor 16 and fuel collector 13. This collector has tube 17 for fuel inlet and injectors 14 for fuel delivery into the head of fire tube.

Quantity and composition of powder mixture 2 in ignition cartridges 1, ratio of lengths and diameters of tubes 4,5 and nozzles 9 are chosen for providing the determined values of powder mixture burning velocity, temperature of explosive gases and lengths of hot explosive gases flames formed, as well as the time of flames burning in zone 10 of fuel mixture reverse flows.

Ignition cartridges 1 and tubes 4 for explosive gas outlet are provided with thermal insulation sufficient for eliminating self-ignition of neighboring ignition cartridges.

The number ignition cartridges 1 installed on the engine shouldn't be less than the number of engine starts prognosed for one operation cycle (one ignition cartridge is used per one starting).

Engines with fire tubes pressure equal to tens or hundreds kg per sq. cm are provided with air-tight compartment 18 where all ignition cartridges 1, tubes 4 and part of tube 5 are enclosed. Compartment 18 is sealed by cover 19. Chamber of the said compartment is pneumatically connected with fire tube 8 chamber for equalizing pressure. Cover 19 serves for changing a set of cartridges (e.g. a magazine with cartridges) before operation cycle (in particular, before starting a flying vehicle).

Fuel ignition system functions in the following way.

In the process of engine starting, the starting electric pulse enters ignition torch 3 at the moment calculated by electronic control block 11 on the basis of current gas-dynamic parameters of the engine.

A weak electric pulse is necessary for starting ignition torch 3 (leading to simple technical solutions): voltage of several Volts, current less than 1 Ampere, length—several milliseconds (in contrast to the known electrical ignition systems where voltage supplied to the electric igniter plug is equal to several thousands of Volts, current reaches several thousands Amperes, ignition system consumes up to 100 W (of electric energy per each igniter plug) during 10-40 seconds; for supplying such voltage and current to igniter plug positioned inside the engine, complex and cumbersome heat- and electricity-resistant equipment is necessary). Powder mixture 2 ignites, explosive gases from ignition cartridge 1 formed out of slowly burning powder mixture enter circular collector 6 through tubes 4 and 5. Further, explosive gases through nozzles 9 enter head 7 of fire tube 8 and form flames.

Quantity and composition of powder mixture 2, ratio between lengths and diameters of tubes 4 and 5 and nozzles 9 as well as the pressure in fire tube 8 determine powder mixture burning velocity (e.g., 2 gr. per second), length of flames (several centimeters), time of burning (3 seconds) and explosive gases temperature in flames (1100 K). Flames appear in fire tube ahead of the fuel supply (for 0.5 sec) The figures given here correspond to a definite jet engine where the proposed ignition system was tested.

Length of hot explosive gas flames is longer than the distance between section of nozzle 9 and the zone of reverse flows 10. Explosive gases temperature in the flames mentioned is higher than the temperature of fuel mixture ignition. Hot explosive gas flames occur in fire tube several seconds ahead of the fuel mixture delivery and up to obtaining stable burning along the whole zone of reverse flows in the fire tube.

Characteristics of explosive gas flames mentioned (length of flames, explosive gas temperature, forestalling time and time of burning) have definite values for each type of the engine.

Flames of hot explosive gases have the temperature of 1000-1300 K and the length longer than the distance between the nozzle 9 section (situated on the fire tube wall) and the zone of gas reverse flows even with the largest modern jet engine.

Spraying liquid components of the fuel touch the surface of hot explosive gases flames and evaporate, and the fuel vapors formed are heated to the temperature higher than the temperature of fuel mixture ignition. Overheated fuel vapors ignite within the wide range of “poor” and “rich” mixtures (propellant and oxidant).

Extreme outer conditions for engine starting (extremely low temperatures of the ambient air and fuel, bad fuel spraying, heavy kinds of fuel, high speeds of flying vehicles, low or high pressure in the fire tube) cannot hinder fuel evaporation and ignition on the hot flame surface due to high heat energy of the flames. That's why flames of hot explosive gases can ignite fuel mixture with all the ranges of heights, speeds and temperatures which preserve stable burning regime in the given fire tube.

Heat capacity of the system (ignition cartridge 1, tubes 4,5 collector 6 and nozzles 9) is small relative to thermal energy of hot explosive gases. That's why all the system is heated to the temperature of hot gases within the period of time less than 1 sec (e.g., 0.1 sec). Thus, the gases leaving nozzles 9 are of stable temperature. When fuel ignites on the flame surface, flame front is being formed. The flame front moves along the circumference of the reverse flow zone at great speed (e.g., 5-15 m/sec). Time of attaining the regime of stable burning for ring and spherical fire tubes doesn't exceed one second. For engines with several fire tubes this time depends on the method of flame transfer in between the tubes.

Number of nozzles 9 on fire tubes (two or more) depends on their characteristics determining the speed of flame front.

It follows from the above said that the system of fuel ignition proposed when used as an auxiliary one for the main ignition system really increases safety of flights and stability of exploitation as this system is stable with fuel ignition under any extreme circumstances:
with jet engine starting in winter conditions at extremely low temperatures of air and fuel (including application of heavy kinds of fuel) at passenger, transport and fighting aircrafts as well as in surface facility and armored vehicles,
with emergency starting of jet engines at limiting heights of plane flight after flame-out due to unfavorable weather conditions or sharp evolutions of the plane,
with anti-surge starting,
when starting thrust augmenter.

Ignition system used as the only one in the engine widens the range of stable starting (increases stability of exploitation), considerably increases explosion safety when testing and in flight, decreases the weight of the ignition system set used for starting, in particular:
small-size jet engine,
jet engine at the single flight aircraft or drone,
liquid rocket engine.

The technical solution described herein ensures the accomplishment of the invention object, has all the features of the patentable invention (in particularly it is nonobvious for the specialist in given field) and therefore deserves a patent protection.

### LITERATURE

1. J. R. Marsden “Improvements in or relating to Gas-Turbine Engines”. GB patent No 627,722 dated 1949, Classes 75(iii); F5; and 92(ii); B2b2, B2c(1:2).
2. A. H. Lefebvre “Gas turbine combustion”, printed by Edwards Brothers, Ann Arbor, Mich., 1998.
3. V. I. Baskakov et al. “Ignition torch of rocket oxygen-hydrogen engine”, RU patent No. 2025571 C1, dated Dec. 30, 1994, Int.C1. F02K 9/60.
4. E. Francais “Improvement in or relating to Explosively-Operated Ignition Devices for Jet Engines”, GB patent No 714,800 dated 1954, Class 9(1), A1B1.
5. J. W. Box, A. F. Araujo “Turbine Engine with Solid Fuel Starter”, U.S. Pat. No. 6,374,592 dated Apr. 23, 2002, US C1. 60/39.02; Int.C1. F02C 7/26; F02C 3/26.
6. W. W. Griffin, R. M. Pierce “Vented igniter”, U.S. Pat. No. 4,099,373 dated Jul. 11, 1978, US C1. 60/39.67; Int.C1. F02C 7/18; F02C 7/26.
7. A. L. Schuler, D. R. Willey “Liquid-Solid Propulsion System and Method”, U.S. Pat. No. 5,099,645 dated Mar. 31, 1992; US C1. 60/219; Int. C1. F02K 9/28; F02K 11/00.
8. J. G. Asquith et al. “Bootstrap Re-Ignition System for Aircraft Jet Engine”, U.S. Pat. No. 5,442,907 dated Aug. 22, 1995, US C1. 60/39.06; Int. C1. F02C 7/26; F02G 3/00.
9. Y. Sugimoto et al. “Fuel Feed Device for Gas Engines and Gas-Engine-Powered Working Machine”, U.S. Pat. No. 5,799,640 dated Sep. 1, 1998, US C1. 123/527; Int. C1. F02M 31/125.

I claim:

1. A system of fuel ignition for jet engine, e.g. flying vehicle, starting comprising:
a set of ignition cartridges having a number of cartridges not less than the number of prognosed engine starts in one operation cycle, where each ignition cartridge with powder mixture and ignition torch is connected by the pipe for explosive gas outlet to the engine through intermediate elements, and the said pipe is connected to the tube leading to the tubular circular collector,
the said collector is positioned in front of the fire tube head,
hereby the collector is fitted with outlet tubes having nozzles at their end, each nozzle being situated on the fire tube head and enters the fire tube,
and each nozzle is oriented inside the fire tube so that during starting flames of hot explosive gases are formed in the zone of fuel mixture reverse flows ahead time for fuel delivery, with the length of the said flames longer than the distance between the nozzle section and reverse flow zone, and with explosive gases temperature higher than that of fuel mixture ignition,
in this case ignition torches of cartridges are connected to an electronic control block which provides for the calculated moment of the electric pulse being sent to the ignition torch (device) and the initial moment of supplying fuel to the fuel collector with injectors, each positioned in the fire tube head.

2. The system according to claim 1, wherein the quantity and composition of the powder mixture, ratio between lengths and diameters of tubes and nozzles have been chosen for providing the given values of powder mixture burning velocity, temperature of explosive gases formed and length of explosive gas flames, as well as the time of flames burning in the zone of fuel mixture reverse flows.

3. The system according to claim 1, where the said tubular collector is made in the form of an incomplete ring.

4. The system according to claim 1, where ignition cartridges and tubes for explosive gas outlet are fitted with thermal insulation sufficient for eliminating self-ignition of neighboring ignition cartridges.

5. The system according to claim 1, where the set of ignition cartridges, tubes for explosive gases outlet and part of the tube connected to a circular collector is placed in an air-tight compartment with an air-tight cover, and the compartment chamber is pneumatically connected to the fire tube chamber for equalizing pressure.
